(19) United States
(12) Patent Application Publication
(10) Pub. No.: US 2025/0196548 A1
(43) Pub. Date: Jun. 19, 2025

(54) HEAVY DUTY TIRE

(71) Applicant: SUMITOMO RUBBER INDUSTRIES, LTD., Kobe-shi (JP)

(72) Inventor: Masayuki YOSHINO, Kobe-shi (JP)

(73) Assignee: SUMITOMO RUBBER INDUSTRIES, LTD., Kobe-shi (JP)

(21) Appl. No.: 18/950,416

(22) Filed: Nov. 18, 2024

(30) Foreign Application Priority Data
Dec. 15, 2023 (JP) 2023-211734

(51) Int. Cl. B60C 19/00; B60C 13/02; B60C 15/06

(52) U.S. Cl. CPC B60C 19/00; B60C 13/02; B60C 15/0632; B60C 2019/004; B60C 2200/06

(57) ABSTRACT

A tire 2 includes a pair of beads 10, a carcass 12 including a carcass ply 36, a pair of sidewalls 6, a pair of chafers 8, and a tag member 22 including an RFID tag 54. The carcass ply 36 includes a ply body 38 and a pair of turned-up portions 40. A plurality of recesses 62 are provided on a side surface 26, of the tire 2, which includes a maximum width position PW of the tire 2. An end PF of the turned-up portion 40 and the plurality of recesses 62 overlap a boundary BS between the sidewall 6 and the chafer 8. Among the plurality of recesses 62, the recess 62 located on a radially outermost side is a first recess 62a, and the RFID tag 54 is located radially inward of the maximum width position PW and located radially outward of the first recess 62a.

### CROSS REFERENCE TO RELATED APPLICATION

This application claims priority on Japanese Patent Application No. 2023-211734 filed on Dec. 15, 2023, the entire content of which is incorporated herein by reference.

### TECHNICAL FIELD

The present invention relates to heavy duty tires.

### BACKGROUND ART

In order to manage data regarding manufacturing management, customer information, running history, etc., of tires, incorporation of radio frequency identification (RFID) tags into tires has been proposed. Various studies have been conducted on the technology to incorporate an RFID tag into a tire (for example, PATENT LITERATURE 1 below).

### CITATION LIST

### Patent Literature

PATENT LITERATURE 1: Japanese Laid-Open Patent Publication No. 2021-046057

### SUMMARY OF THE INVENTION

### Technical Problem

An object of the present invention is to provide a heavy duty tire that can suppress occurrence of surface cracks (Superficial Crack: SFC), which influence the appearance quality, while maintaining durability.

### Solution to Problem

A heavy duty tire according to the present invention includes a pair of beads, a carcass extending on and between the pair of beads, a tread located radially outward of the carcass, a pair of sidewalls located axially outward of the carcass, a pair of chafers located radially inward of the sidewall and configured to come into contact with a rim, and a tag member including an RFID tag. Each bead includes a core and an apex located radially outward of the core. The carcass includes a carcass ply. The carcass ply includes a ply body extending between the pair of beads and a pair of turned-up portions connected to the ply body and turned up at the beads. A plurality of recesses aligned in a circumferential direction are provided on a side surface, of the tire, which includes a maximum width position of the tire. An end of the turned-up portion and the plurality of recesses overlap a boundary between the sidewall and the chafer in an axial view. Among the plurality of recesses, a recess located on a radially outermost side is a first recess. The RFID tag is located radially inward of the maximum width position and located radially outward of the first recess.

### Advantageous Effects of the Invention

According to the present invention, a heavy duty tire that can suppress occurrence of SFC, which influences the appearance quality, while maintaining durability, is obtained.

### BRIEF DESCRIPTION OF DRAWINGS

FIG. 1 is a cross-sectional view showing a part of a heavy duty tire according to one embodiment of the present invention.

FIG. 2 is a cross-sectional view showing a part of the tire in FIG. 1.

FIG. 3 is a plan view of a tag member.

FIG. 4 is a cross-sectional view taken along a line IV-IV in FIG. 3.

FIG. 5 is a front view showing a part of a bead portion.

FIG. 6 is a front view showing the opening of a recess

FIG. 7 is a cross-sectional view of recesses.

### DETAILED DESCRIPTION

The following will describe in detail the present invention based on preferred embodiments with appropriate reference to the drawings.

A tire of the present disclosure is fitted on a rim. The interior of the tire is filled with air to adjust the internal pressure of the tire. The tire fitted on the rim is also referred to as tire-rim assembly. The tire-rim assembly includes the rim and the tire fitted on the rim.

In the present disclosure, a state where a tire is fitted on a normal rim, the internal pressure of the tire is adjusted to a normal internal pressure, and no load is applied to the tire is referred to as a normal state.

In the present disclosure, unless otherwise specified, the dimensions and angles of each component of the tire are measured in the normal state.

The dimensions and angles of each component in a meridian cross-section of the tire, which cannot be measured in a state where the tire is fitted on the normal rim, are measured in a cut surface of the tire obtained by cutting the tire along a plane including the rotation axis of the tire. In this measurement, the tire is set such that the distance between right and left beads is equal to the distance between the beads in the tire that is fitted on the normal rim. A component, of the tire, which cannot be confirmed in a state where the tire is fitted on the normal rim is confirmed in the above-described cut surface.

The normal rim means a rim specified in a standard on which the tire is based. The “standard rim” in the JATMA standard, the “Design Rim” in the TRA standard, and the “Measuring Rim” in the ETRTO standard are normal rims.

The normal internal pressure means an internal pressure specified in the standard on which the tire is based. The “highest air pressure” in the JATMA standard, the “maximum value” recited in the “TIRE LOAD LIMITS AT VARIOUS COLD INFLATION PRESSURES” in the TRA standard, and the “INFLATION PRESSURE” in the ETRTO standard are normal internal pressures.

A normal load means a load specified in the standard on which the tire is based. The “maximum load capacity” in the JATMA standard, the “maximum value” recited in the “TIRE LOAD LIMITS AT VARIOUS COLD INFLATION PRESSURES” in the TRA standard, and the “LOAD CAPACITY” in the ETRTO standard are normal loads.

In the present disclosure, a complex elastic modulus of a component formed from a crosslinked rubber, from among the components included in the tire, is measured according to the standard of JIS K6394 using a viscoelasticity spectrometer. The measurement conditions are as follows.
Initial strain=10%
Dynamic strain==1%
Frequency=10 Hz
Mode=stretch mode
Temperature=70° C.

In this measurement, a test piece (a length of 40 mm×a width of 4 mm×a thickness of 1 mm) is sampled from the tire. The length direction of the test piece is caused to coincide with the circumferential direction of the tire. When a test piece cannot be sampled from the tire, a test piece is sampled from a sheet-shaped crosslinked rubber (hereinafter, also referred to as a rubber sheet) obtained by pressurizing and heating a rubber composition, which is used for forming the component to be measured, at a temperature of 170° C. for 12 minutes.

In the present disclosure, the complex elastic modulus is represented as a complex elastic modulus at 70° C.

In the present disclosure, a tread portion of the tire is a portion of the tire that comes into contact with a road surface. A bead portion is a portion of the tire that is fitted to a rim. A sidewall portion is a portion of the tire that extends between the tread portion and the bead portion. The tire includes a tread portion, a pair of bead portions, and a pair of sidewall portions as portions thereof.

[Findings on which the Present Disclosure is Based]

If an RFID tag is incorporated into a tire, the state of strain changes relative to a tire in which an RFID tag is not incorporated. Therefore, the incorporation of the RFID tag may influence the durability of the tire.

In a heavy duty tire, each bead portion has high stiffness. In the case where an RFID tag is provided in a heavy duty tire, the RFID tag is placed in a bead portion from the viewpoint of being able to suppress the influence of the RFID tag on durability.

There is a known technology of providing a plurality of recesses (also called dimples) aligned in the circumferential direction for the purpose of improving durability. If a plurality of recesses aligned in the circumferential direction are provided, for example, in each bead portion, turbulent flow is generated as the tire runs, and this turbulent flow cools the bead portion.

In order to effectively suppress a decrease in durability due to the incorporation of the RFID tag, including damage to the RFID tag itself, it is considered to provide the RFID tag at a position overlapping a recess in the thickness direction of the tire.

The portion where each recess is provided is thinner than the portion where no recess is provided. Surface strain of the tire in a normal state tends to be larger at each recess (specifically, the bottom of each recess).

If the RFID tag is placed at a position overlapping the recess in the thickness direction of the tire, the rubber of the portion covering the RFID tag at the recess becomes even thinner. At the portion covering the RFID tag, the surface strain increases, so that there is a concern that the risk of occurrence of SFC which influences the appearance quality increases.

Therefore, the present inventor has conducted a thorough study for the positional relationship between the recess and the RFID tag that can suppress occurrence of SFC while maintaining durability, and thus has completed the present disclosure described below.

### [Outline of Embodiments of Present Disclosure]

The present disclosure is directed to a heavy duty tire including a pair of beads, a carcass extending on and between the pair of beads, a tread located radially outward of the carcass, a pair of sidewalls located axially outward of the carcass, a pair of chafers located radially inward of the sidewall and configured to come into contact with a rim, and a tag member including an RFID tag, wherein: each bead includes a core and an apex located radially outward of the core; the carcass includes a carcass ply; the carcass ply includes a ply body extending between the pair of beads and a pair of turned-up portions connected to the ply body and turned up at the beads; a plurality of recesses aligned in a circumferential direction are provided on a side surface, of the tire, which includes a maximum width position of the tire; an end of the turned-up portion and the plurality of recesses overlap a boundary between the sidewall and the chafer in an axial view; among the plurality of recesses, a recess located on a radially outermost side is a first recess; and the RFID tag is located radially inward of the maximum width position and located radially outward of the first recess.

The heavy duty tire of the present disclosure can suppress occurrence of SFC while maintaining durability. The mechanism by which this effect is achieved has not been clarified, but is inferred as follows.

The end of the turned-up portion is located axially inward of the boundary between the sidewall and the chafer, and the plurality of recesses are provided axially outward of this boundary. As the tire runs, turbulent flow is generated, and this turbulent flow effectively cools a bead portion. Accordingly, the durability of the bead portion is improved.

Furthermore, the RFID tag is placed between the maximum width position of the tire and the first recess located on the radially outermost side, among the plurality of recesses. Concentration of strain on the RFID tag is suppressed, so that a decrease in durability due to the incorporation of the RFID tag, including damage to the RFID tag itself, is suppressed. The durability of the bead portion is effectively improved.

The RFID tag is placed at a position, in the bead portion of the tire, which does not overlap any recess in the thickness direction of the tire. Occurrence of SFC which is a concern in the case where the RFID tag is placed so as to overlap the recess in the thickness direction of the tire, is suppressed. Furthermore, the turbulent air flows to the radially outer side of the recess due to the action of centrifugal force, so that heat generated by the operation of the RFID tag is also effectively dissipated. The tire can effectively suppress a decrease in durability due to the incorporation of the RFID tag, including damage to the RFID tag itself.

The tire can suppress occurrence of SFC, which influences the appearance quality, while maintaining durability.

Preferably, the apex includes an inner apex and an outer apex which is more flexible than the inner apex, the inner apex is located radially outward of the core, the outer apex is located radially outward of the inner apex, and the tag member is adjacent to the outer apex on a radially inner side of an outer end of the outer apex. In this case, since the tag member is stacked on the flexible outer apex on the radially inner side of the maximum width position of the tire, concentration of strain on the RFID tag is effectively suppressed. The tire can maintain good durability. An increase in surface strain due to the provision of the RFID tag can also be suppressed, so that occurrence of SFC is also suppressed.

Since the outer apex is located between the RFID tag and the ply body, the RFID tag is placed so as to be spaced apart from the ply body. Even if the carcass ply includes steel cords as carcass cords, radio waves are less likely to be disturbed. The tire allows a good communication environment to be formed between the RFID tag and a communication device (not shown). Writing of data to the RFID tag and reading of data recorded in the RFID tag are more accurately performed.

Preferably, the tag member is adjacent to the outer apex on a radially outer side of an outer end of the chafer. In this case, concentration of strain on the RFID tag is effectively suppressed, so that the tire can maintain good durability. An increase in surface strain due to the provision of the RFID tag can also be suppressed, so that occurrence of SFC is also suppressed. Since the RFID tag is placed so as to be spaced apart from the ply body, the tire allows a good communication environment to be formed between the RFID tag and a communication device (not shown).

Preferably, the first recess is located radially inward of the outer end of the chafer. The stiffness of the bead portion changes greatly at the outer end of the chafer, and in this case, the first recess is placed avoiding the portion where the stiffness changes greatly. Surface strain generated at the recess is reduced, so that occurrence of SFC at the recess is effectively suppressed.

Preferably, the outer end of the chafer is located between the first recess and the RFID tag in a radial direction. In this case, occurrence of SFC at the recess is effectively suppressed.

Preferably, the plurality of recesses each include an opening which is rectangular and longer in the circumferential direction than in a radial direction, the opening includes a pair of side edges extending in the radial direction, an outer edge and an inner edge located between the pair of side edges and extending in the circumferential direction, a pair of outer boundary edges connecting the outer edge and the side edges, and a pair of inner boundary edges connecting the inner edge and the side edges, the inner edge is located radially inward of the outer edge, a contour of each outer boundary edge and a contour of each inner boundary edge are each represented by an arc, and a radius of the arc representing the contour of each outer boundary edge is larger than a radius of the arc representing the contour of each inner boundary edge. In this case, surface strain generated at each recess is effectively reduced, so that occurrence of SFC at each recess is more effectively suppressed.

Preferably, the plurality of recesses include a plurality of the first recesses aligned in the circumferential direction and a plurality of second recesses aligned in the circumferential direction, a row of the plurality of the second recesses aligned in the circumferential direction is located radially inward of a row of the plurality of the first recesses aligned in the circumferential direction, the first recesses and the second recesses are arranged alternately in the circumferential direction, and a radius of an arc representing a contour of each outer boundary edge of each first recess is larger than a radius of an arc representing a contour of each outer boundary edge of each second recess. In this case, surface strain generated at each recess is effectively reduced, so that occurrence of SFC at each recess is more effectively suppressed.

The present inventor has also checked the occurrence of SFC in a tire provided with a plurality of recesses aligned in the circumferential direction, and has found that SFC is less likely to occur on the radially outer side of recesses located on the radially outermost side among the plurality of recesses. Based on this finding, preferably, the plurality of recesses include a plurality of the first recesses aligned in the circumferential direction, and at least a part of the RFID tag overlaps at least one of the first recesses in the radial direction. In this case, even though the rubber of the portion covering the RFID tag is thin, the tire can effectively suppress occurrence of SFC.

### DETAILS OF EMBODIMENTS OF PRESENT DISCLOSURE

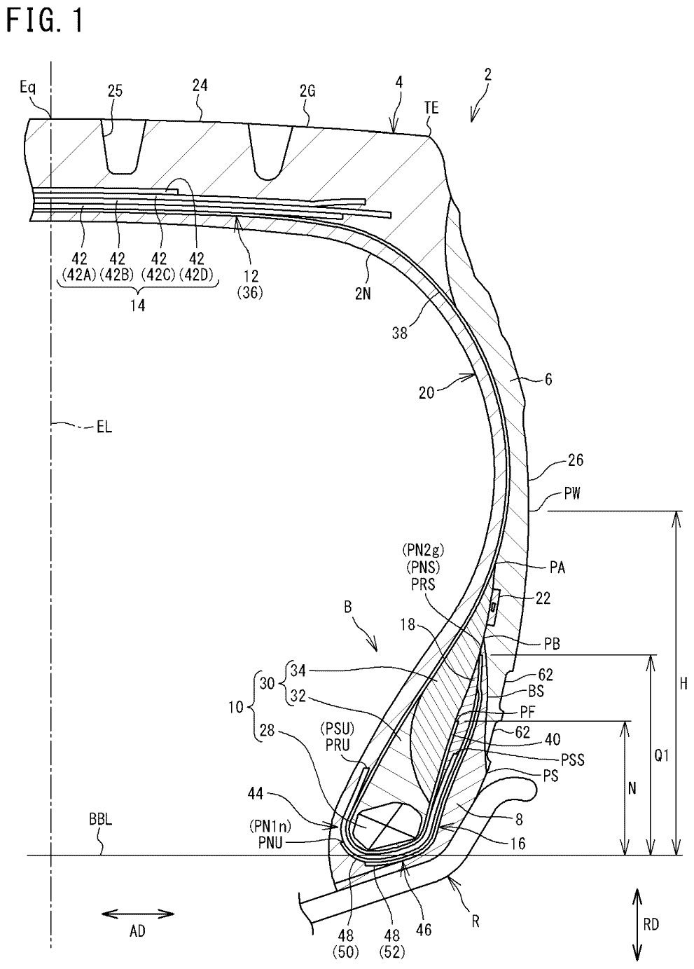

FIG. 1 shows a part of a heavy duty tire 2 (hereinafter also referred to simply as “tire 2”) according to an embodiment of the present disclosure. The tire 2 is mounted to a vehicle such as a truck and a bus.

In FIG. 1, the tire 2 is fitted on a rim R (normal rim).

FIG. 1 shows a part of a cross-section (hereinafter referred to as meridian cross-section) of the tire 2 along a plane including the rotation axis of the tire 2. A direction indicated by a double-headed arrow AD is the axial direction of the tire 2. The axial direction of the tire 2 means a direction parallel to the rotation axis of the tire 2. A direction indicated by a double-headed arrow RD is the radial direction of the tire 2. A direction perpendicular to the surface of the drawing sheet of FIG. 1 is the circumferential direction of the tire 2. An alternate long and short dash line EL represents the equator plane of the tire 2.

In FIG. 1, a solid line BBL extending in the axial direction is a bead base line. The bead base line BBL is a line that defines the rim diameter (see JATMA or the like) of the rim R.

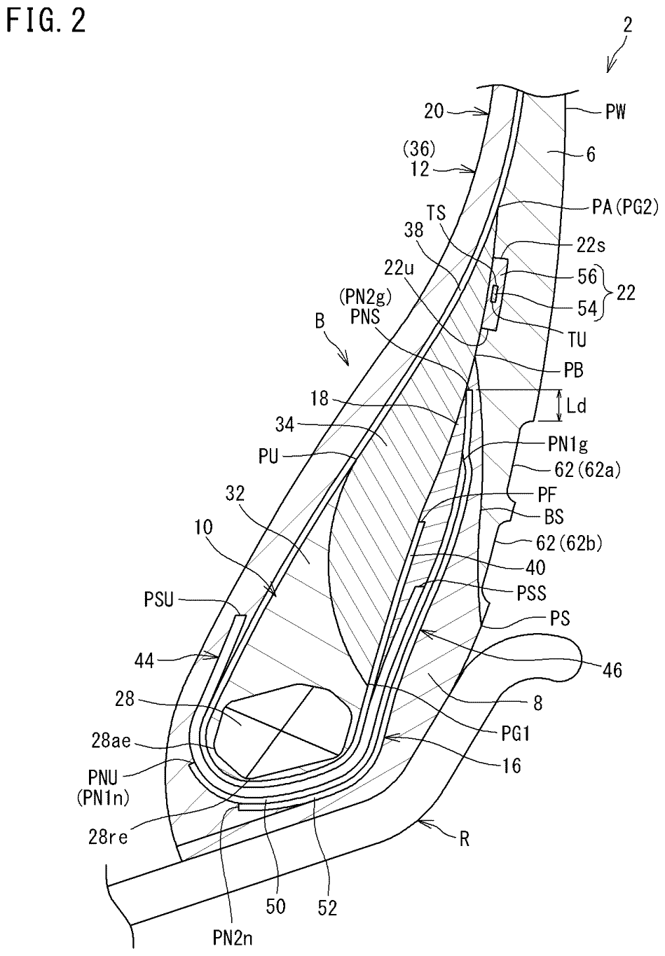

FIG. 2 shows the cross-section shown in FIG. 1. FIG. 2 shows a bead portion B of the tire 2.

The tire 2 includes a tread 4, a pair of sidewalls 6, a pair of chafers 8, a pair of beads 10, a carcass 12, a belt 14, a pair of reinforcing layers 16, a pair of interlayer strips 18, an inner liner 20, and a tag member 22.

The tread 4 is located radially outward of the carcass 12. The tread 4 includes a tread surface 24. The tread 4 comes into contact with a road surface at the tread surface 24. Grooves 25 are formed on the tread 4.

The tread 4 is formed from a crosslinked rubber. Although not described in detail, a portion, of the tread 4, including the tread surface 24 is formed from a crosslinked rubber for which wear resistance and grip performance are taken into consideration. The other portion of the tread 4 is formed from a crosslinked rubber that has low heat generation properties.

A position indicated by reference sign TE is an end of the tread surface 24. The tread surface 24 is a part of an outer surface 2G of the tire 2. Although not described in detail, the outer surface 2G of the tire 2 is shaped by a mold (not shown). An inner surface 2N of the tire 2 is shaped, for example, by a bladder (not shown).

In FIG. 1, a position indicated by reference sign Eq corresponds to an equator. The equator Eq is the point of intersection of the tread surface 24 and the equator plane EL. The tread surface 24 includes the equator Eq. Although not shown, in the case where the groove 25 is located on the equator plane EL, the equator Eq is specified on the basis of a virtual tread surface obtained on the assumption that the groove 25 is not present thereon.

The distance in the radial direction, from the bead base line BBL to the equator Eq, obtained in the tire 2 in the normal state is the cross-sectional height (see JATMA or the like) of the tire 2.

Each sidewall 6 is connected to an end of the tread 4. The sidewall 6 is located radially inward of the tread 4. The sidewall 6 is located axially outward of the carcass 12. A position indicated by reference sign PS is an inner end of the sidewall 6.

The sidewall 6 is formed from a crosslinked rubber for which cut resistance is taken into consideration. The complex elastic modulus of the sidewall 6 is not less than 2.0 MPa and not greater than 6.0 MPa.

The sidewall 6 is thin in the vicinity of a maximum width position described later, and gradually thickens from the maximum width position toward an outer end of the chafer 8 described later. The sidewall 6 is tapered from the outer end of the chafer 8 toward the inner end PS of the sidewall 6.

Each chafer 8 is located radially inward of the sidewall 6. The chafer 8 comes into contact with the rim R. A position indicated by reference sign PB is the outer end of the chafer 8.

The chafer 8 is formed from a crosslinked rubber for which wear resistance is taken into consideration. The complex elastic modulus of the chafer 8 is not less than 10 MPa and not greater than 15 MPa. The chafer 8 is harder than the sidewall 6.

The sidewall 6 and the chafer 8 form a side surface 26 of the tire 2. The side surface 26 is a part of the outer surface 2G of the tire 2 and is connected to the tread surface 24.

The outer surface 2G of the tire 2 includes the tread surface 24 and a pair of the side surfaces 26.

The outer end PB of the chafer 8 is located radially outward of the inner end PS of the sidewall 6. The outer end PB of the chafer 8 is an outer end of a boundary BS between the chafer 8 and the sidewall 6. The inner end PS of the sidewall 6 is an inner end of the boundary BS between the chafer 8 and the sidewall 6.

In the tire 2, the outer end PB of the sidewall 6 is included in the side surface 26 of the tire 2. The outer end PB of the chafer 8 is covered with the sidewall 6. The inner end PS of the sidewall 6 may be covered with the chafer 8. In this case, the outer end PB of the chafer 8 is included in the side surface 26 of the tire 2.

A position indicated by reference sign PW is an axially outer end (hereinafter referred to as outer end PW) of the tire 2. The tire 2 has a maximum width at the outer end PW. The outer end PW is also referred to as maximum width position. The side surface 26 of the tire 2 includes the maximum width position PW.

In the case where decorations such as patterns and letters are present on the side surface 26, the outer end PW is specified on the basis of a virtual side surface (hereinafter referred to as reference surface of the side surface 26) obtained on the assumption that the decorations are not present thereon. Although not described in detail, the reference surface of the side surface 26 in the meridian cross-section of the tire 2 is represented using a plurality of arcs or straight lines.

In the present disclosure, the distance in the axial direction, from a first outer end PW to a second outer end PW (not shown), obtained in the tire 2 in the normal state is the cross-sectional width (see JATMA or the like) of the tire 2.

In FIG. 1, a length indicated by a double-headed arrow H is the distance in the radial direction from the bead base line BBL to the maximum width position PW. The distance H in the radial direction is also referred to as radial height of the maximum width position PW. In the tire 2 in the normal state, the ratio of the radial height H of the maximum width position PW to the cross-sectional height is not less than 0.40 and not greater than 0.60.

Each bead 10 is located axially inward of the chafer 8. The bead 10 is located radially inward of the sidewall 6.

The bead 10 includes a core 28 and an apex 30.

The core 28 extends in the circumferential direction. The core 28 includes a wound wire made of steel which is not shown. The core 28 has a substantially hexagonal cross-sectional shape.

The apex 30 is located radially outward of the core 28. The apex 30 extends radially outward from the core 28. The apex 30 is tapered outward. A position indicated by reference sign PA is an outer end of the apex 30. The outer end PA of the apex 30 is located radially outward of the outer end PB of the chafer 8.

The apex 30 includes an inner apex 32 and an outer apex 34. The inner apex 32 is located radially outward of the core 28. The outer apex 34 is located radially outward of the inner apex 32.

The inner apex 32 is tapered outward. An outer end PU of the inner apex 32 is located radially inward of the outer end PB of the chafer 8. The inner apex 32 is formed from a hard crosslinked rubber. The complex elastic modulus of the inner apex 32 is not less than 60 MPa and not greater than 90 MPa.

The outer apex 34 is thick in the vicinity of the outer end PU of the inner apex 32. The outer apex 34 is tapered inward and tapered outward from the thick portion thereof.

An inner end PG1 of the outer apex 34 is located near the core 28. An outer end PG2 of the outer apex 34 is also the outer end PA of the apex 30.

The outer apex 34 is formed from a crosslinked rubber. The outer apex 34 is more flexible than the inner apex 32. The complex elastic modulus of the outer apex 34 is not less than 3.0 MPa and not greater than 6.0 MPa. The outer apex 34 is more flexible than the chafer 8. The outer apex 34 is substantially equal to the sidewall 6 in stiffness, or is harder than the sidewall 6.

The carcass 12 is located inward of the tread 4, the pair of sidewalls 6, and the pair of chafers 8. The carcass 12 extends on and between the pair of beads 10. The carcass 12 of the tire 2 has a radial structure.

The carcass 12 includes at least one carcass ply 36. The carcass 12 of the tire 2 is composed of one carcass ply 36. The carcass ply 36 is turned up at the beads 10.

The carcass ply 36 has a ply body 38 and a pair of turned-up portions 40. The ply body 38 extends between the pair of beads 10, that is, between a first bead 10a and a second bead 10b (not shown). Each turned-up portion 40 is connected to the ply body 38 and turned up at the bead 10. The turned-up portion 40 of the tire 2 is turned up at the bead 10 from the inner side toward the outer side in the axial direction. An end PF of the turned-up portion 40 is located radially inward of the outer end PB of the chafer 8. The above-described outer end PU of the inner apex 32 is located radially outward of the end PF of the turned-up portion 40. The bead 10 is interposed between the ply body 38 and the turned-up portion 40.

The carcass ply 36 includes a large number of carcass cords aligned with each other, which are not shown. These carcass cords are covered with a topping rubber. Each carcass cord intersects the equator plane EL. The material of each carcass cord is steel. In other words, a steel cord is used as each carcass cord.

In FIG. 1, a length indicated by a double-headed arrow N is the distance in the radial direction from the bead base line BBL to the end PF of the turned-up portion 40. The distance N in the radial direction is also referred to as radial height of the end PF of the turned-up portion 40.

The ratio (N/H) of the radial height N of the end PF of the turned-up portion 40 to the radial height H of the maximum width position PW is not less than 0.25 and not greater than 0.45.

The belt 14 includes four belt plies 42. The four belt plies 42 are a first belt ply 42A, a second belt ply 42B, a third belt ply 42C, and a fourth belt ply 42D from the radially inner side. These belt plies 42 are aligned in the radial direction.

Among the four belt plies 42, the first belt ply 42A is located on the radially innermost side. The second belt ply 42B has a widest width, and the fourth belt ply 42D has a narrowest width.

Each belt ply 42 includes a large number of belt cords aligned with each other, which are not shown. Each belt cord is tilted with respect to the equator plane EL. The material of each belt cord is steel. In other words, a steel cord is used as each belt cord.

Each reinforcing layer 16 is located between the carcass 12 and the chafer 8. The reinforcing layer 16 of the tire 2 includes a steel reinforcing layer 44 and a fiber reinforcing layer 46.

The steel reinforcing layer 44 is located between the carcass 12 and the fiber reinforcing layer 46. The steel reinforcing layer 44 is located outward of the carcass 12 and turned up at the bead 10. The steel reinforcing layer 44 is placed so as to wrap a radially inner portion of the bead 10 from the radially inner side of the carcass 12. An inner end PSU of the steel reinforcing layer 44 is located between the carcass 12 and the inner liner 20. The inner end PSU of the steel reinforcing layer 44 is located between the outer end PU of the inner apex 32 and the core 28 in the radial direction. An outer end PSS of the steel reinforcing layer 44 is located between the end PF of the turned-up portion 40 and the inner end PSU of the steel reinforcing layer 44 in the radial direction. The outer end PSS of the steel reinforcing layer 44 is located between the turned-up portion 40 and the fiber reinforcing layer 46 in the axial direction.

The steel reinforcing layer 44 includes a large number of reinforcing cords aligned with each other, which are not shown. The material of the reinforcing cords of the steel reinforcing layer 44 is steel. The steel reinforcing layer 44 includes steel cords, and the steel cords are covered with a topping rubber.

The fiber reinforcing layer 46 is located between the steel reinforcing layer 44 and the chafer 8.

An outer end PNS of the fiber reinforcing layer 46 is located radially outward of the end PF of the turned-up portion 40. The outer end PNS of the fiber reinforcing layer 46 is located radially inward of the outer end PB of the chafer 8. An axially outer portion, of the fiber reinforcing layer 46, including the outer end PNS is located between the steel reinforcing layer 44 and the chafer 8 in the axial direction. An inner end PNU of the fiber reinforcing layer 46 is located between an axially inner end 28ae and a radially inner end 28re of the core 28 in the radial direction.

The fiber reinforcing layer 46 includes two reinforcement plies 48, that is, a first reinforcing ply 50 and a second reinforcing ply 52. The first reinforcing ply 50 is located on the bead 10 side, and the second reinforcing ply 52 is located on the outer surface 2G side of the tire 2. The second reinforcing ply 52 is stacked on the first reinforcing ply 50. An inner end PN1n of the first reinforcing ply 50 is the inner end PNU of the fiber reinforcing layer 46. An outer end PN2g of the second reinforcing ply 52 is the outer end PNS of the fiber reinforcing layer 46.

An outer end PN1g of the first reinforcing ply 50 is located radially inward of the outer end PN2g of the second reinforcing ply 52. The outer end PN1g of the first reinforcing ply 50 is covered with the second reinforcing ply 52.

An inner end PN2n of the second reinforcing ply 52 is located radially inward of the core 28. The inner end PN2n of the second reinforcing ply 52 is located axially outward of the inner end PN1n of the first reinforcing ply 50. A part of the first reinforcing ply 50 protrudes from the inner end PN2n of the second reinforcing ply 52.

Each reinforcing ply 48 includes a large number of reinforcing cords aligned with each other, which are not shown. Each reinforcing cord of the reinforcing ply 48 included in the fiber reinforcing layer 46 is a cord formed from an organic fiber, that is, an organic fiber cord. The organic fiber is preferably a nylon fiber. The two reinforcing plies 48 included in the fiber reinforcing layer 46 each include organic fiber cords, and the organic fiber cords are covered with a topping rubber.

In the tire 2, the first reinforcing ply 50 and the second reinforcing ply 52 are overlaid on each other such that the organic fiber cords included in the first reinforcing ply 50 intersect the organic fiber cords included in the second reinforcing ply 52.

In FIG. 1, a length indicated by a double-headed arrow Q1 is the distance in the radial direction from the bead base line BBL to the outer end PNS of the fiber reinforcing layer 46. The distance Q1 in the radial direction is also referred to as radial height of the outer end PNS of the fiber reinforcing layer 46.

The ratio (Q1/H) of the radial height Q1 of the outer end PNS of the fiber reinforcing layer 46 to the radial height H of the maximum width position PW is not less than 0.40 and not greater than 0.80.

Each interlayer strip 18 is located between the fiber reinforcing layer 46 and the apex 30 (specifically, the outer apex 34) in the axial direction. The interlayer strip 18 covers the end PF of the turned-up portion 40 and the outer end PSS of the steel reinforcing layer 44.

The interlayer strip 18 is in contact with the apex 30 on the radially outer side of the end PF of the turned-up portion 40.

The interlayer strip 18 is in contact with the fiber reinforcing layer 46 on the radially outer side of the outer end PSS of the steel reinforcing layer 44.

The interlayer strip 18 is formed from a crosslinked rubber. The interlayer strip 18 is harder than the sidewall 6 and is more flexible than the chafer 8. The interlayer strip 18 is harder than the outer apex 34. The complex elastic modulus of the interlayer strip 18 is not less than 7.0 MPa and not greater than 12 MPa.

The inner liner 20 is located inward of the carcass 12. The inner liner 20 is joined to the inner surface of the carcass 12 via an insulation (not shown) formed from a crosslinked rubber. The inner liner 20 forms the inner surface 2N of the tire 2. The inner liner 20 is formed from a crosslinked rubber that has an excellent air blocking property. The inner liner 20 maintains the internal pressure of the tire 2.

The tag member 22 is located axially outward of the bead 10. The tag member 22 is covered with the sidewall 6. The tag member 22 is provided only on the side of one sidewall 6 out of the pair of sidewalls 6 provided in the tire 2. The tag member 22 may be provided on each of the side of the one sidewall 6 and the side of the other sidewall 6. From the viewpoint of reducing the risk of a decrease in durability, it is preferable that the tag member 22 is provided on the side of the one sidewall 6 out of the pair of sidewalls 6.

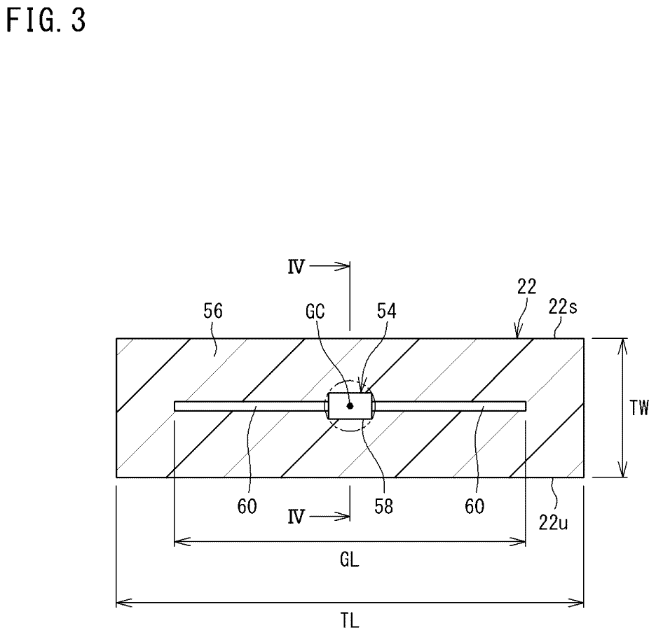

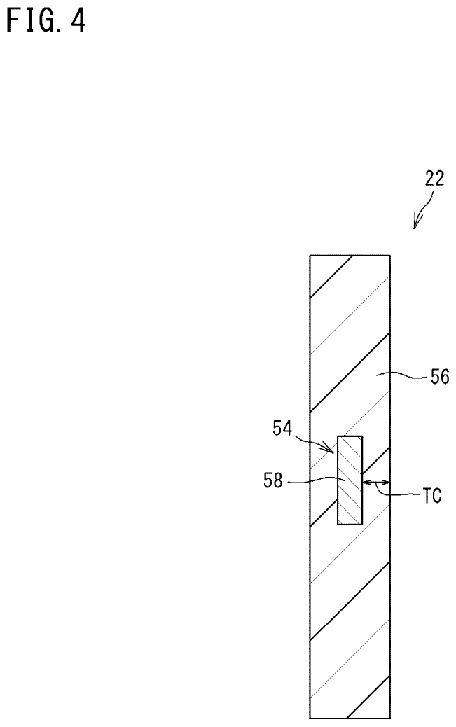

FIG. 3 is a plan view of the tag member 22. FIG. 4 is a cross-sectional view taken along a line IV-IV in FIG. 3.

The tag member 22 has a plate shape. The tag member 22 is long in a length direction thereof and short in a width direction thereof.

As shown in FIG. 2, in the tire 2, the tag member 22 is placed such that a first end 22s in the width direction thereof is located on the radially outer side in the tire 2 and a second end 22u in the width direction thereof is located on the radially inner side in the tire 2. In the tire 2, the first end 22s of the tag member 22 is also referred to as outer end, and the second end 22u thereof is also referred to as inner end.

The tag member 22 includes an RFID tag 54. In FIG. 4, for convenience of description, the RFID tag 54 is shown by a solid line, but the entirety thereof is covered with a protector 56. The tag member 22 includes the RFID tag 54 and the protector 56. The RFID tag 54 is located at the center of the tag member 22. The protector 56 is formed from a crosslinked rubber. The protector 56 has stiffness substantially equal to the stiffness of the outer apex 34. The complex elastic modulus of the protector 56 is not less than 3.0 MPa and not greater than 6.0 MPa.

In the tire 2, formation of a good communication environment is considered, and a crosslinked rubber having high electrical resistance is used for the protector 56. The protector 56 is formed from a rubber that has high insulation properties.

Although not described in detail, the RFID tag 54 is a small and lightweight electronic component that includes: a semiconductor chip 58 obtained by making a transmitter/receiver circuit, a control circuit, a memory, etc., into a chip; and an antenna 60. Upon receiving interrogation radio waves, the RFID tag 54 uses the radio waves as electrical energy and transmits various data in the memory as response radio waves. The RFID tag 54 is a type of passive radio frequency identification transponder.

The RFID tag 54 of the tire 2 includes the semiconductor chip 58 and a pair of antennas 60. The semiconductor chip 58 is located between the pair of antennas 60. Each antenna 60 extends in the length direction of the tag member 22 from the semiconductor chip 58.

In FIG. 3, a position indicated by reference sign GC is the center of the RFID tag 54. The center GC is represented as the center of a circle circumscribing the semiconductor chip 58.

The tag member 22 is a plate-shaped member in which the RFID tag 54 is covered with a crosslinked rubber. The RFID tag 54 is placed in the tag member 22 such that a length direction thereof coincides with the length direction of the tag member 22.

From the viewpoint of reducing the risk of damage to the RFID tag 54 and forming a good communication environment, the thickness of the tag member 22 in the tire 2 is preferably not less than 1.0 mm and not greater than 2.5 mm. The thickness of the tag member 22 in the tire 2 is represented as the maximum thickness of the tag member 22 at the semiconductor chip 58 of the RFID tag 54.

A length TL of the tag member 22 before embedding in the tire 2 is not less than 60 mm and not greater than 80 mm. A width TW thereof is not less than 10 mm and not greater than 20 mm. A length GL of the RFID tag 54 is not less than 30 mm and not greater than 50 mm.

In FIG. 4, a length indicated by a double-headed arrow TC is the thickness of the protector 56 covering the RFID tag 54 (specifically, the semiconductor chip 58) in the tag member 22 before embedding in the tire 2. From the viewpoint of reducing the risk of occurrence of SFC in the tire 2, the thickness TC is preferably not greater than 2.5 mm.

In FIG. 2, a position indicated by reference sign TU is the radially inner end of the RFID tag 54 (specifically, the semiconductor chip 58). A position indicated by reference sign TS is the radially outer end of the semiconductor chip 58, that is, the radially outer end of the RFID tag 54.

In the present disclosure, the case where the inner end TU of the RFID tag 54 in the tire 2 is located radially outward of a position serving as a reference (hereinafter referred to as reference position) is the case where the RFID tag 54 is located on the radially outer side with respect to the reference position. The case where the outer end TS of the RFID tag 54 in the tire 2 is located radially inward of the reference position is the case where the RFID tag 54 is located on the radially inner side with respect to the reference position.

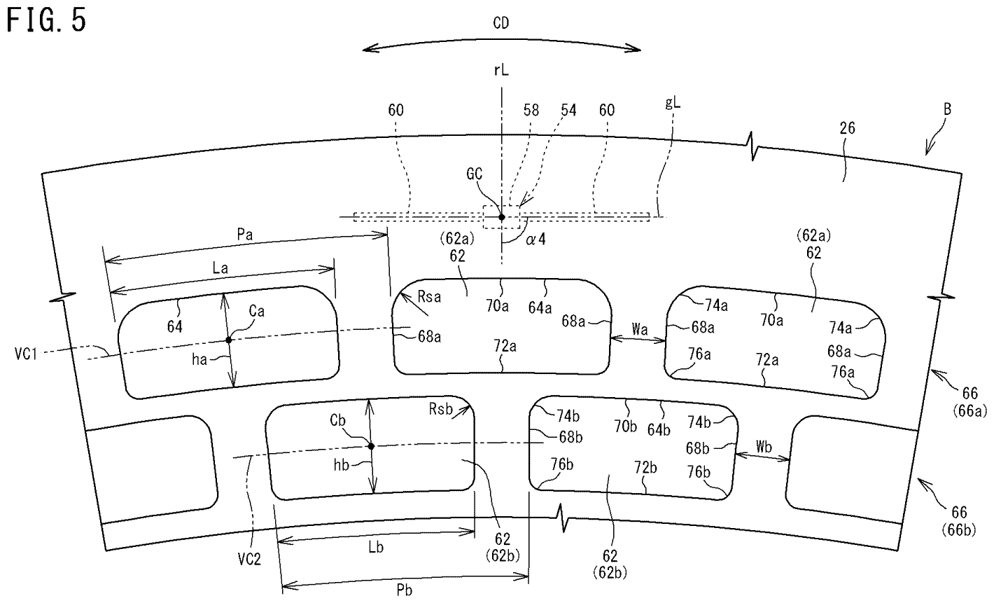

FIG. 5 shows the bead portion B. The tire 2 includes a pair of bead portions B. A direction indicated by a double-headed arrow CD is the circumferential direction of the tire 2.

A plurality of recesses 62 are provided on the side surface 26 of the tire 2. The plurality of recesses 62 are provided on the bead portion B. In the tire 2, the plurality of recesses 62 are provided on each of the pair of bead portions B. The plurality of recesses 62 may be provided only on one bead portion B.

Each recess 62 is a depression and also called a dimple. The contour of each recess 62 shown in FIG. 5 is the contour of an opening 64 of the recess 62. The plurality of recesses 62 each include an opening 64. The opening 64 is rectangular. The opening 64 is long in the circumferential direction and short in the radial direction. The plurality of recesses each include The opening 64 is rectangular and longer in the circumferential direction than in a radial direction.

Among the plurality of recesses 62, the recesses 62 located on the radially outermost side are first recesses 62a, and the recesses 62 located radially inward of the first recesses 62a are second recesses 62b.

The plurality of recesses 62 are aligned in the circumferential direction. As shown in FIG. 5, a row of a plurality of first recesses 62a aligned in the circumferential direction and a row of a plurality of second recesses 62b aligned in the circumferential direction are formed in the bead portion B of the tire 2.

The plurality of recesses 62 include the plurality of first recesses 62a aligned in the circumferential direction and the plurality of second recesses 62b aligned in the circumferential direction, and the row of the plurality of second recesses 62b aligned in the circumferential direction (hereinafter referred to as second recess row 66b) are located radially inward of the row of the plurality of first recesses 62a aligned in the circumferential direction (hereinafter referred to as first recess row 66a).

The first recesses 62a and the second recesses 62b are arranged alternately in the circumferential direction. As shown in FIG. 2, the second recesses 62b are located radially outward of the inner end PS of the sidewall 6.

As shown in FIG. 2, the end PF of the turned-up portion 40 of the carcass ply 36 overlaps the boundary BS between the sidewall 6 and the chafer 8 in an axial view. The plurality of recesses 62 also overlap the boundary BS between the sidewall 6 and the chafer 8 in an axial view. In other words, the end PF of the turned-up portion 40 and the plurality of recesses 62 overlap the boundary BS between the sidewall 6 and the chafer 8 in an axial view.

As the tire 2 runs, each row of recesses 62 aligned in the circumferential direction, that is, each recess row 66, generates turbulent flow. Air replacement is promoted at each recess 62, so that heat dissipation of the portion where each recess 62 is provided is promoted. Accordingly, the portion where each recess row 66 is provided (i.e., the bead portion B) is cooled.

As described above, each carcass cord of the tire 2 is a steel cord. Strain is likely to be concentrated on the end PF of the turned-up portion 40, so that damage due to the end PF of the turned-up portion 40 is likely to occur.

In the tire 2, the end PF of the turned-up portion 40 is located axially inward of the boundary BS between the sidewall 6 and the chafer 8, and the plurality of recesses 62 are provided axially outward of the boundary BS. As the tire 2 runs, turbulent flow is generated, and this turbulent flow effectively cools the bead portion B. Accordingly, a decrease in durability due to the end PF of the turned-up portion 40 is suppressed. In the tire 2, the durability of the bead portion B is improved.

As described above, each reinforcing cord of the steel reinforcing layer 44 is also a steel cord. As shown in FIG. 2, the outer end PSS of the steel reinforcing layer 44 also overlaps the boundary BS between the sidewall 6 and the chafer 8 in an axial view. In the tire 2, the cooling effect of the plurality of recesses 62 suppresses a decrease in durability due to the outer end PSS of the steel reinforcing layer 44. In the tire 2, the durability of the bead portion B is improved.

As shown in FIG. 2, the RFID tag 54 is placed between the maximum width position PW and the first recesses 62a.

As described above, each sidewall 6 of the tire 2 gradually thickens from the maximum width position PW toward the outer end PB of the chafer 8. Since the RFID tag 54 is located radially inward of the maximum width position PW, the RFID tag 54 is covered with the sidewall 6 having an appropriate thickness. Concentration of strain on the RFID tag 54 is suppressed, so that a decrease in durability due to the incorporation of the RFID tag 54, including damage to the RFID tag 54 itself, is suppressed. The durability of the bead portion B is effectively improved.

As described above, the first recesses 62a are the recesses 62 located on the radially outermost side, among the plurality of recesses 62. The RFID tag 54 is located radially outward of the first recess 62a located on the radially outermost side. The RFID tag 54 is placed at a position, in the bead portion B of the tire 2, which does not overlap any recess 62 in the thickness direction of the tire 2. Occurrence of SFC, which is a concern in the case where the RFID tag 54 is placed so as to overlap the recess 62 in the thickness direction of the tire 2, is suppressed. Furthermore, the turbulent air flows to the radially outer side of the first recess 62a due to the action of centrifugal force, so that heat generated by the operation of the RFID tag 54 is also effectively dissipated. The tire 2 can effectively suppress a decrease in durability due to the incorporation of the RFID tag 54, including damage to the RFID tag 54 itself.

The tire 2 can suppress occurrence of SFC, which influences the appearance quality, while maintaining durability.

As shown in FIG. 2, the tag member 22 is adjacent to the outer apex 34 on the radially inner side of the outer end PG2 of the outer apex 34, i.e., the outer end PA of the apex 30. As described above, the RFID tag 54 is located radially inward of the maximum width position PW of the tire 2. Since the tag member 22 is stacked on the flexible outer apex 34, concentration of strain on the RFID tag 54 is effectively suppressed. The tire 2 can maintain good durability. An increase in surface strain due to the provision of the RFID tag 54 can also be suppressed, so that occurrence of SFC is also suppressed.

Since the outer apex 34 is located between the RFID tag 54 and the ply body 38, the RFID tag 54 is placed so as to be spaced apart from the ply body 38. As described above, the carcass ply 36 of the tire 2 includes steel cords as the carcass cords. Since the RFID tag 54 is placed so as to be spaced apart from the ply body 38, radio waves are less likely to be disturbed. The tire 2 allows a good communication environment to be formed between the RFID tag 54 and a communication device (not shown). Writing of data to the RFID tag 54 and reading of data recorded in the RFID tag 54 are more accurately performed. From this viewpoint, it is preferable that the tag member 22 is adjacent to the outer apex 34 on the radially inner side of the outer end PG2 of the outer apex 34. In this case, it is more preferable that the outer end 22s of the tag member 22 is located radially inward of the outer end PG2 of the outer apex 34.

As described above, each sidewall 6 of the tire 2 is tapered from the outer end PB of the chafer 8 toward the inner end PS of the sidewall 6. If the tag member 22 is provided radially inward of the outer end PB of the chafer 8, the sidewall 6 becomes thinner, so that strain may be concentrated on the RFID tag 54.

However, as shown in FIG. 2, the tag member 22 is adjacent to the outer apex 34 on the radially outer side of the outer end PB of the chafer 8. The tag member 22 is covered with the sidewall 6 having an appropriate thickness. The tag member 22 is in contact with both the outer apex 34 and the sidewall 6. Concentration of strain on the RFID tag 54 is effectively suppressed, so that the tire 2 can maintain good durability. An increase in surface strain due to the provision of the RFID tag 54 can also be suppressed, so that occurrence of SFC is also suppressed. Since the outer apex 34 is located axially inward of the RFID tag 54, the RFID tag 54 is placed so as to be spaced apart from the ply body 38. The tire 2 allows a good communication environment to be formed between the RFID tag 54 and a communication device (not shown). From this viewpoint, it is preferable that the tag member 22 is adjacent to the outer apex 34 on the radially outer side of the outer end PB of the chafer 8. In this case, it is more preferable that the inner end 22u of the tag member 22 is located radially outward of the outer end PB of the chafer 8.

The stiffness of the bead portion B changes greatly at the outer end PB of the chafer 8. The stiffness of a radially outer portion from the outer end PB of the chafer 8 is lower than the stiffness of a radially inner portion from the outer end PB of the chafer 8.

As shown in FIG. 2, the first recesses 62a are located radially inward of the outer end PB of the chafer 8. In the tire 2, the first recesses 62a are located avoiding the portion where the stiffness changes greatly. Surface strain generated at each recess 62 is reduced, so that occurrence of SFC at each recess 62 is effectively suppressed. From this viewpoint, it is preferable that the first recesses 62a are located radially inward of the outer end PB of the chafer 8. It is more preferable that the outer end PB of the chafer 8 is located between the first recess 62a and the RFID tag 54 in the radial direction.

As shown in FIG. 2, the first recesses 62a are located radially inward of the outer end PNS of the fiber reinforcing layer 46. In this case as well, the first recesses 62a are located avoiding the portion where the stiffness changes greatly. Surface strain generated at each recess 62 is reduced, so that occurrence of SFC at each recess 62 is effectively suppressed. From this viewpoint, it is preferable that the first recesses 62a are located radially inward of the outer end PNS of the fiber reinforcing layer 46. In this case, a length Ld in the radial direction from the first recess 62a to the outer end PNS of the fiber reinforcing layer 46 is preferably not less than 3.0 mm and not greater than 10.0 mm.

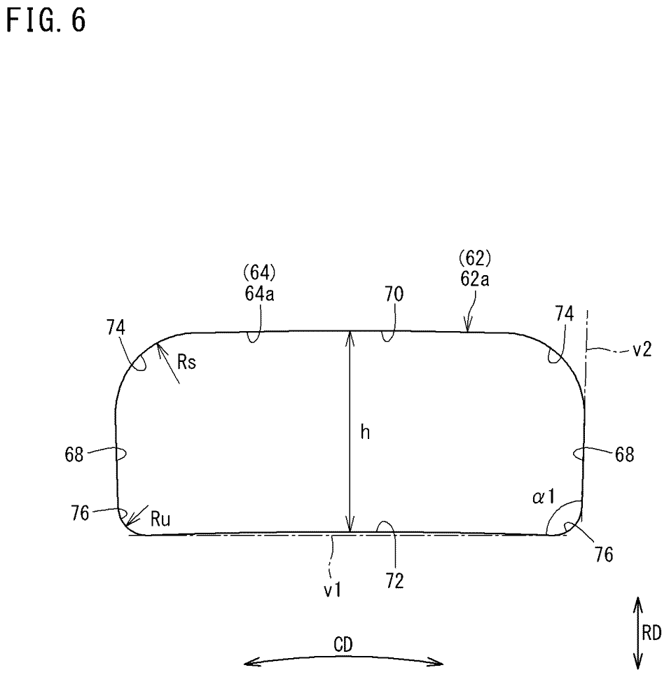

FIG. 6 shows an opening 64a of the first recess 62a. The basic configuration of the opening 64 of each recess 62 will be described based on the opening 64a of the first recess 62a.

The opening 64 includes a pair of side edges 68, an outer edge 70, an inner edge 72, a pair of outer boundary edges 74, and a pair of inner boundary edges 76.

The pair of side edges 68 of the tire 2 extend in the radial direction. The contour of each side edge 68 is represented by a straight line. The contour of the side edge 68 may be represented by a straight line inclined with respect to the radial direction.

The outer edge 70 and the inner edge 72 extend in the circumferential direction. The contour of the outer edge 70 is represented by an arc having a center at the rotation axis of the tire 2. The contour of the outer edge 70 may be represented by a straight line. The contour of the inner edge 72 is represented by an arc having a center at the rotation axis of the tire 2. The contour of the inner edge 72 may be represented by a straight line.

The pair of outer boundary edges 74 connect the side edges 68 and the outer edge 70. The contour of each outer boundary edge 74 is represented by an arc. In FIG. 6, an arrow Rs indicates the radius of the arc representing the contour of the outer boundary edge 74.

The pair of inner boundary edges 76 connect the side edges 68 and the inner edge 72. The contour of each inner boundary edge 76 is represented by an arc. In FIG. 6, an arrow Ru indicates the radius of the arc representing the contour of the inner boundary edge 76.

A length indicated by a double-headed arrow h is the width of the recess 62. The width h is represented as the length from the outer edge 70 to the inner edge 72 measured along the radial direction. In the case where the width h changes in the circumferential direction, the width h is represented as the maximum width.

The contours of the four corners of the opening 64 of the recess 62 are represented by arcs. The four corners of the opening 64, i.e., each outer boundary edge 74 and each inner boundary edge 76, can effectively alleviate strain acting on the recess 62. From this viewpoint, each of the contour of each outer boundary edge 74 and the contour of each inner boundary edge 76 is preferably represented by an arc. In this case, the ratio (h/Rs) of the width h of the recess 62 to the radius Rs of the arc representing the contour of the outer boundary edge 74 is preferably not less than 1 and not greater than 10.

When the ratio (h/Rs) is set to be not less than 1, the tire 2 can maintain high stiffness in the vicinity of the outer boundary edge 74 of the recess 62 and effectively suppress occurrence of SFC. From this viewpoint, the ratio (h/Rs) is more preferably not less than 2.

When the ratio (h/Rs) is set to be not greater than 10, a decrease in the stiffness of the bead portion B due to the provision of the recess 62 is effectively suppressed. From this viewpoint, the ratio (h/Rs) is more preferably not greater than 8.

Larger strain is likely to be generated at a radially outer portion of the recess 62 than at a radially inner portion of the recess 62. There is a concern that SFC is more likely to occur at the radially outer portion of the recess 62 than at the radially inner portion of the recess 62.

However, in the tire 2, the radius Rs of the arc representing the contour of the outer boundary edge 74 is larger than the radius Ru of the arc representing the contour of the inner boundary edge 76. Accordingly, the tire 2 can maintain high stiffness of the radially outer portion of the recess 62. In the tire 2, occurrence of SFC at the recess 62 is effectively suppressed. From this viewpoint, it is preferable that the radius Rs of the arc representing the contour of the outer boundary edge 74 is larger than the radius Ru of the arc representing the contour of the inner boundary edge 76. Specifically, the ratio (Rs/Ru) of the radius Rs of the arc representing the contour of the outer boundary edge 74 to the radius Ru of the arc representing the contour of the inner boundary edge 76 is preferably greater than 1.0, more preferably 1.5, and further preferably not less than 2.0. The ratio (Rs/Ru) is preferably not greater than 4.0 and more preferably not greater than 3.5.

In FIG. 6, an angle indicated by reference sigh α1 is an angle between the side edge 68 and the inner edge 72. In the tire 2, the angle α1 is represented as an angle between a virtual straight line v1 circumscribing the recess 62 from the radially inner side and a virtual straight line v2 including the straight line representing the contour of the side edge 68.

In the tire 2, the angle α1 is preferably not less than 70 degrees and not greater than 95 degrees.

When the angle α1 is set to be not less than 70 degrees, the outer edge 70 is formed with an appropriate length. Since the outer edge 70 having appropriate stiffness is formed, occurrence of SFC is effectively suppressed. From this viewpoint, the angle α1 is more preferably not less than 75 degrees.

When the angle α1 is set to be not greater than 95 degrees, concentration of strain on the outer boundary edge 74 is effectively suppressed. In the tire 2, occurrence of SFC which occurs in the vicinity of the outer boundary edge 74 is suppressed. From this viewpoint, the angle α1 is more preferably not greater than 90 degrees.

In the tire 2, it is preferable that a radius Rsa of an arc representing the contour of each outer boundary edge 74a of each first recess 62a is larger than a radius Rsb of an arc representing the contour of each outer boundary edge 74b of each second recess 62b. In this case, the vicinity of the first recess 62a where larger strain is generated is maintained at high stiffness. In the tire 2, occurrence of SFC is effectively suppressed. From this viewpoint, the ratio (Rsa/Rsb) of the radius Rsa of the arc representing the contour of the outer boundary edge 74a of the first recess 62a to the radius Rsb of the arc representing the contour of the outer boundary edge 74b of the second recess 62b is preferably not less than 1.2 and more preferably not less than 1.5.

The ratio (Rsa/Rsb) is preferably not greater than 3. Accordingly, an outer edge 70a of the first recess 62a can have an appropriate length, and the stiffness of the outer edge 70a is effectively increased. In this case as well, occurrence of SFC is effectively suppressed. From this viewpoint, the ratio (Rsa/Rsb) is more preferably not greater than 2.5.

In FIG. 5, a position indicated by reference sign Ca indicates the center in the width direction at a position where a width ha of the first recess 62a is measured. An alternate long and two short dashes line VC1 is a virtual line passing through the center Ca in the width direction of the first recess 62a and extending in the circumferential direction. A length indicated by a double-headed arrow La is the length in the circumferential direction of the first recess 62a. A length indicated by a double-headed arrow Pa is the pitch in the circumferential direction of the first recess 62a. The length La in the circumferential direction and the pitch Pa in the circumferential direction of the first recess 62a are measured along the virtual line VC1. The pitch Pa in the circumferential direction of the first recess 62a is constant in the circumferential direction. The first recesses 62a are arranged at equal intervals in the circumferential direction.

A position indicated by reference sign Cb indicates the center in the width direction at a position where a width hb of the second recess 62b is measured. An alternate long and two short dashes line VC2 is a virtual line passing through the center Cb in the width direction of the second recess 62b and extending in the circumferential direction. A length indicated by a double-headed arrow Lb is the length in the circumferential direction of the second recess 62b. A length indicated by a double-headed arrow Pb is the pitch in the circumferential direction of the second recess 62b. The length Lb in the circumferential direction and the pitch Pb in the circumferential direction of the second recess 62b are measured along the virtual line VC2. The pitch Pb in the circumferential direction of the second recess 62b is a constant pitch in the circumferential direction. The second recesses 62b are arranged at equal intervals in the circumferential direction.

From the viewpoint that each first recess 62a can sufficiently exhibit its cooling function, the ratio (La/Pa) of the length La in the circumferential direction to the pitch Pa in the circumferential direction of the first recess 62a is preferably not less than 0.50 and more preferably not less than 0.55. The ratio (La/Pa) is preferably not greater than 0.85 and more preferably not greater than 0.80.

From the viewpoint that each second recess 62b can sufficiently exhibit its cooling function, the ratio (Lb/Pb) of the length Lb in the circumferential direction to the pitch Pb in the circumferential direction of the second recess 62b is preferably not less than 0.60 and more preferably not less than 0.65. The ratio (Lb/Pb) is preferably not greater than 0.85 and more preferably not greater than 0.80.

From the viewpoint of being able to improve the durability of the bead portion B and effectively suppress occurrence of SFC, it is preferable that the ratio (La/Pa) is not less than 0.50 and not greater than 0.85 and the ratio (Lb/Pb) is not less than 0.60 and not greater than 0.85.

In FIG. 5, a double-headed arrow Wa indicates the distance between two adjacent first recesses 62a. A double-headed arrow Wb indicates the distance between two adjacent second recesses 62b.

In the tire 2, the distance Wa between the two adjacent first recesses 62a gradually increases toward the radially outer side. The tire 2 can maintain a radially outer portion of the tire 2 where large strain is generated during running, at high stiffness. The tire 2 can effectively suppress occurrence of SFC. From this viewpoint, it is preferable that the distance Wa between the two adjacent first recesses 62a gradually increases toward the radially outer side.

In the tire 2, the distance Wb between the two adjacent second recesses 62b gradually increases toward the radially outer side. The tire 2 can maintain the radially outer portion of the tire 2 where large strain is generated during running, at high stiffness. The tire 2 can effectively suppress occurrence of SFC. From this viewpoint, it is preferable that the distance Wb between the two adjacent second recesses 62b gradually increases toward the radially outer side.

From the viewpoint of reducing the risk of occurrence of SFC, it is preferable that the distance Wa between the two adjacent first recesses 62a gradually increases toward the radially outer side and the distance Wb between the two adjacent second recesses 62b gradually increases toward the radially outer side.

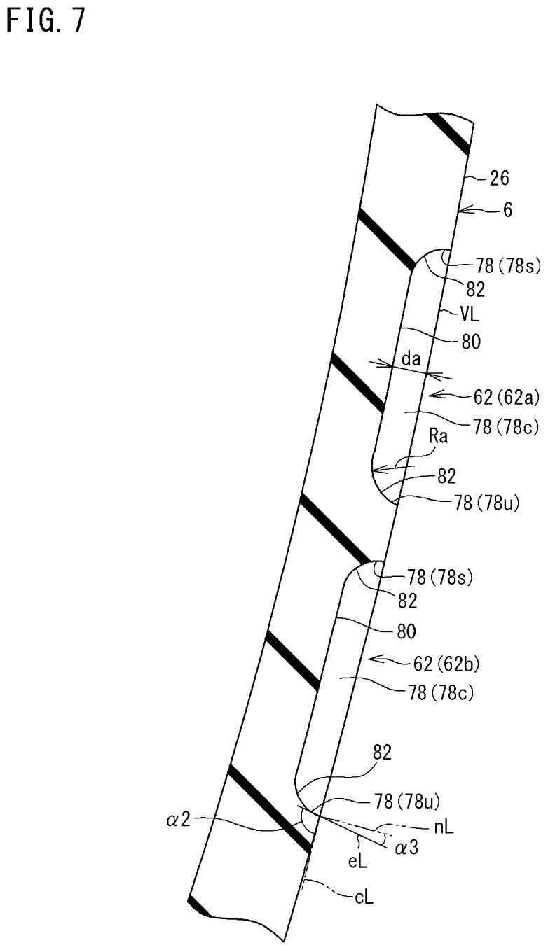

FIG. 7 shows a part of the cross-section of the tire 2 shown in FIG. 1. FIG. 7 shows cross-sections of the recesses 62.

Each recess 62 includes a wall surface 78, a bottom surface 80, and a connection surface 82. The wall surface 78 is a surface extending inward from a reference surface VL of the side surface 26 of the tire 2.

In FIG. 7, a length indicated by a double-headed arrow da is the depth of the recess 62. The bottom surface 80 is formed as a surface spaced inward from the reference surface VL by a distance corresponding to the depth da. In the tire 2, the depth da of the recess 62 is, for example, not less than 1.0 mm and not greater than 4.0 mm.

The connection surface 82 is a surface connecting the wall surface 78 and the bottom surface 80. In the cross-section of the recess 62, the contour of the connection surface 82 is represented by an arc. In FIG. 7, an arrow Ra indicates the radius of the arc representing the contour of the connection surface 82.

The recess 62 includes, as the wall surface 78, an outer wall surface 78s and an inner wall surface 78u located so as to oppose each other in the radial direction, and a pair of intermediate wall surfaces 78c located so as to oppose each other in the circumferential direction. The arcs representing the contours of the connection surface 82 connected to the outer wall surface 78s, the connection surface 82 connected to the inner wall surface 78u, and the connection surface 82 connected to each intermediate wall surface 78c all have the same radius Ra.

In the tire 2, the first recesses 62a and the second recesses 62b have the same depth da, and the arcs representing the contours of the connection surfaces 82 of the first recesses 62a and the arcs representing the contours of the connection surfaces 82 of the second recesses 62b have the same radius Ra.

In the tire 2, in each recess 62, the radius Ra of the arc representing the contour of the connection surface 82 is larger than the depth da of the recess 62. Accordingly, the stiffness in the vicinity of the outer wall surface 78s, of the recess 62, located on the radially outer side is increased. Concentration of strain generated in the vicinity of the outer wall surface 78s is reduced, so that occurrence of SFC which is likely to occur in the vicinity of the recess 62 is suppressed. The tire 2 can effectively suppress occurrence of SFC. From this viewpoint, it is preferable that in each recess 62, the radius Ra of the arc representing the contour of the connection surface 82 is larger than the depth da of the recess 62.

In the tire 2, from the viewpoint of being able to effectively suppress generation of strain at the recess 62, the radius Ra of the arc representing the contour of the connection surface 82 is preferably not less than 1.8 mm and preferably not greater than 5.0 mm.

In FIG. 7, an alternate long and two short dashes line cL is a tangent line of the reference surface VL of the side surface 26 at the boundary between the wall surface 78 and the reference surface VL. An alternate long and two short dashes line nL is a normal line of the reference surface VL at the above boundary. A solid line eL is an extension line of the wall surface 78.

An angle α2 is an angle between the extension line eL and the tangent line cL. The angle α2 is an inner inclination angle of the wall surface 78. An angle α3 is an angle between the extension line eL and the normal line nL. The angle α3 is an outer inclination angle of the wall surface 78.

From the viewpoint of being able to maintain high stiffness of the recess 62 and enhance the cooling effect by turbulent flow, the inner inclination angle α2 is preferably an obtuse angle. From the same viewpoint, the outer inclination angle α3 is preferably not less than 10 degrees and not greater than 30 degrees, and more preferably not less than 15 degrees and not greater than 25 degrees. It is preferable that the inner inclination angle α2 is an obtuse angle and the outer inclination angle α3 is not less than 10 degrees and not greater than 30 degrees.

For example, as shown in FIG. 5, a part of the incorporated RFID tag 54 overlaps one first recess 62a in the radial direction. This placement of the RFID tag 54 is based on the above-described finding that in a tire provided with a plurality of recesses aligned in the circumferential direction, SFC is less likely to occur on the radially outer side of recesses located on the radially outermost side. Therefore, even though the rubber of the portion covering the RFID tag 54 is thin, the tire 2 can effectively suppress occurrence of SFC. From this viewpoint, it is preferable that at least a part of the RFID tag 54 overlaps one first recess 62a in the radial direction. It is more preferable that the semiconductor chip 58 of the RFID tag 54 overlaps the one first recess 62a in the radial direction, and it is further preferable that the semiconductor chip 58 overlaps the outer edge 70a of the one first recess 62a in the radial direction.

In FIG. 5, an alternate long and two short dashes line rL is a virtual straight line passing through the center GC of the RFID tag 54 and extending in the radial direction. An alternate long and two short dashes line gL is a virtual straight line passing through the center GC of the RFID tag 54 and extending in the length direction of the RFID tag 54. An angle α4 is an angle between the virtual straight line rL and the virtual straight line gL. The angle α4 is an angle of the length direction of the RFID tag 54 with respect to the radial direction. The angle α4 is also called a tilt angle of the RFID tag 54.

In the tire 2, from the viewpoint of effectively suppressing occurrence of SFC, which influences the appearance quality, while maintaining durability, the tilt angle α4 is preferably not less than 65 degrees and not greater than 90 degrees, more preferably not less than 75 degrees and not greater than 90 degrees, and further preferably not less than 85 degrees and not greater than 90 degrees.

As is obvious from the above description, according to the present disclosure, the heavy duty tire 2 that can suppress occurrence of SFC, which influences the appearance quality, while maintaining durability, is obtained.

### EXAMPLES

The following will describe the present invention in further detail by means of examples, etc., but the present invention is not limited to these examples.

### Example 1

A tire (size=315/80R22.5) having the basic structure shown in FIG. 1 to FIG. 7 was obtained. The RFID tag was placed between the maximum width position PW and the first recess in the radial direction. The RFID tag did not overlap the bottom surface of the first recess in the thickness direction of the tire.

### Comparative Example 1

A tire of Comparative Example 1 was obtained in the same manner as Example 1, except that the RFID tag was placed so as to overlap the bottom surface of the first recess in the thickness direction of the tire.

### [SFC Resistance Performance]

Each test tire was fitted onto a rim (size=22.5×9.00) and inflated with air to adjust the internal pressure of the tire to 830 kPa. The tire was mounted to a drum type tire testing machine. In an atmosphere in which the ozone concentration was adjusted to 50 pphm, a load of 38.56 kN was applied as a vertical load and the tire was run on a drum at a speed of 40 km/h. After running for 400 hours, the appearance of the tire was observed to check the occurrence of SFC.

In Comparative Example 1, SFC was observed at the bottom surface of the first recess located directly above the RFID tag. In contrast, in Example 1, SFC was not observed not only at the bottom surface of the recess but also at the portion where the RFID tag was embedded. From the evaluation results, advantages of the present invention are clear.

### INDUSTRIAL APPLICABILITY

The above-described technology capable of suppressing a decrease in durability due to the presence of an RFID tag can be applied to various tires.

### REFERENCE SIGNS LIST

2 tire
4 tread
6 sidewall
8 chafer
10 bead
12 carcass
14 belt
16 reinforcing layer
22 tag member
24 tread surface
26 side surface
28 core
30 apex
32 inner apex
34 outer apex
36 carcass ply
38 ply body
40 turned-up portion
44 steel reinforcing layer
46 fiber reinforcing layer
54 RFID tag
56 protector
58 semiconductor chip
60 antenna
62, 62a, 62b recess
64 opening
68 side edge
70 outer edge
72 inner edge
74 outer boundary edge
76 inner boundary edge
78, 78s, 78u, 78c wall surface
80 bottom surface
82 connection surface

1. A heavy duty tire comprising a pair of beads, a carcass extending on and between the pair of beads, a tread located radially outward of the carcass, a pair of sidewalls located axially outward of the carcass, a pair of chafers located radially inward of the sidewall and configured to come into contact with a rim, and a tag member including an RFID tag, wherein
each bead includes a core and an apex located radially outward of the core,
the carcass includes a carcass ply,
the carcass ply includes a ply body extending between the pair of beads and a pair of turned-up portions connected to the ply body and turned up at the beads,
a plurality of recesses aligned in a circumferential direction are provided on a side surface, of the tire, which includes a maximum width position of the tire,
an end of the turned-up portion and the plurality of recesses overlap a boundary between the sidewall and the chafer in an axial view,
among the plurality of recesses, a recess located on a radially outermost side is a first recess, and
the RFID tag is located radially inward of the maximum width position and located radially outward of the first recess.

2. The heavy duty tire according to claim 1, wherein
the apex includes an inner apex and an outer apex which is more flexible than the inner apex,
the inner apex is located radially outward of the core,
the outer apex is located radially outward of the inner apex, and
the tag member is adjacent to the outer apex on a radially inner side of an outer end of the outer apex.

3. The heavy duty tire according to claim 2, wherein the tag member is adjacent to the outer apex on a radially outer side of an outer end of the chafer.

4. The heavy duty tire according to claim 1, wherein the first recess is located radially inward of an outer end of the chafer.

5. The heavy duty tire according to claim 4, wherein the outer end of the chafer is located between the first recess and the RFID tag in a radial direction.

6. The heavy duty tire according to claim 1, wherein
the plurality of recesses each include an opening which is rectangular and longer in the circumferential direction than in a radial direction,
the opening includes a pair of side edges extending in the radial direction, an outer edge and an inner edge located between the pair of side edges and extending in the circumferential direction, a pair of outer boundary edges connecting the outer edge and the side edges, and a pair of inner boundary edges connecting the inner edge and the side edges,
the inner edge is located radially inward of the outer edge,
a contour of each outer boundary edge and a contour of each inner boundary edge are each represented by an arc, and
a radius of the arc representing the contour of each outer boundary edge is larger than a radius of the arc representing the contour of each inner boundary edge.

7. The heavy duty tire according to claim 6, wherein
the plurality of recesses include a plurality of the first recesses aligned in the circumferential direction and a plurality of second recesses aligned in the circumferential direction,
a row of the plurality of the second recesses aligned in the circumferential direction is located radially inward of a row of the plurality of the first recesses aligned in the circumferential direction,
the first recesses and the second recesses are arranged alternately in the circumferential direction, and
a radius of an arc representing a contour of each outer boundary edge of each first recess is larger than a radius of an arc representing a contour of each outer boundary edge of each second recess.

8. The heavy duty tire according to claim 1, wherein
the plurality of recesses include a plurality of the first recesses aligned in the circumferential direction, and
at least a part of the RFID tag overlaps at least one of the first recesses in a radial direction.

9. The heavy duty tire according to claim 7, wherein
each second recess is a recess located on a radially outermost side among the plurality of recesses, and
each second recess is located radially outward of an inner end of the sidewall.

10. The heavy duty tire according to claim 1, further comprising a reinforcing layer located between the carcass and each of the sidewalls, wherein
the reinforcing layer includes a steel reinforcing layer including steel cords and a fiber reinforcing layer including organic fiber cords,
the steel reinforcing layer is placed so as to wrap a radially inner portion of the bead from a radially inner side of the carcass,
the fiber reinforcing layer is located between the steel reinforcing layer and each of the chafers,
an outer end of the fiber reinforcing layer is located radially outward of an end of the turned-up portion, and
the first recess is located radially inward of an outer end of the fiber reinforcing layer.

11. The heavy duty tire according to claim 6, wherein
the plurality of recesses include a plurality of the first recesses aligned in the circumferential direction,
the RFID tag includes a semiconductor chip and a pair of antennas,
the semiconductor chip is located between the pair of antennas,
each of the antennas extends in the length direction of the tag member from the semiconductor chip, and
the semiconductor chip overlaps the outer edge of one of the first recess in the radial direction.

12. The heavy duty tire according to claim 1, wherein
the first recess is located radially inward of an outer end of the chafer, and
at least a part of the RFID tag overlaps the first recesses in a radial direction.

13. The heavy duty tire according to claim 1, wherein
the plurality of recesses include a plurality of the first recesses aligned in the circumferential direction and a plurality of second recesses aligned in the circumferential direction,
a row of the plurality of the second recesses aligned in the circumferential direction is located radially inward of a row of the plurality of the first recesses aligned in the circumferential direction,
the first recesses and the second recesses are arranged alternately in the circumferential direction,
each first recess is located radially inward of an outer end of the chafer,
each second recess is located radially outward of an inner end of the sidewall, and
each second recess is a recess located on a radially outermost side among the plurality of recesses.

14. The heavy duty tire according to claim 6, wherein
the plurality of recesses include a plurality of the first recesses aligned in the circumferential direction and a plurality of second recesses aligned in the circumferential direction,
a row of the plurality of the second recesses aligned in the circumferential direction is located radially inward of a row of the plurality of the first recesses aligned in the circumferential direction,
the first recesses and the second recesses are arranged alternately in the circumferential direction,
each first recess is located radially inward of an outer end of the chafer,
each second recess is located radially outward of an inner end of the sidewall,
each second recess is a recess located on a radially outermost side among the plurality of recesses and
at least a part of the RFID tag overlaps at least one of the first recesses in a radial direction.

15. The heavy duty tire according to claim 1, further comprising a reinforcing layer located between the carcass and each of the sidewalls, wherein
the reinforcing layer includes a steel reinforcing layer including steel cords and a fiber reinforcing layer including organic fiber cords,
the steel reinforcing layer is placed so as to wrap a radially inner portion of the bead from a radially inner side of the carcass,
the fiber reinforcing layer is located between the steel reinforcing layer and each of the chafers,
an outer end of the fiber reinforcing layer is located radially outward of an end of the turned-up portion,
the first recess is located radially inward of an outer end of the fiber reinforcing layer and
at least a part of the RFID tag overlaps the first recesses in a radial direction.
